(19) United States
(12) Patent Application Publication
(10) Pub. No.: US 2009/0134599 A1
(43) Pub. Date: May 28, 2009

(54) Swivel Hitch and Method of Using Same

(75) Inventor: Neil Edwin Bowsher, Sullivan, IL (US)

Correspondence Address: VEDDER PRICE P.C., 222 N. LASALLE STREET, CHICAGO, IL, 60601, US

(73) Assignee: AGRI-FAB, INC., Sullivan, IL (US)

(21) Appl. No.: 11/944,938

(22) Filed: Nov. 26, 2007

(51) Int. Cl. B60D 1/07

(52) U.S. Cl. 280/416.1

(57) ABSTRACT

A swivel multi-hitch includes a tongue with a first end adapted to be connected to a vehicle and a second end extending therefrom. The swivel multi-hitch also includes a swivel plate that is configured to be selectively mountable between a work orientation and a storage orientation. Furthermore, a fixation plate is connected to the tongue. When the swivel plate is disposed in the storage orientation, the hitch opening is disposed adjacent to the vehicle. When the swivel plate is disposed in the work orientation, the hitch opening is disposed extended from the ball. A method for using a swivel multi-hitch on a vehicle is also disclosed.

### FIELD OF THE DISCLOSURE

The disclosure generally relates to a hitch for towing and more particularly to a hitch that is usable as both a ball hitch and a pin hitch.

### BACKGROUND

Vehicles come in a variety of forms, including cars, boats, farm machinery (e.g., tractors, harvesters), trucks, and more. While vehicles can serve any number of functions, especially with known adaptations, one important vehicle function is towing. Towing allows vehicles that may be limited in function to be able to quickly adapt to be able to perform additional functions and/or to have additional utility. For example, a truck that can carry a limited volumetric load may be adapted to also tow a trailer with an additional load. As another example, farm machinery may be developed such that instead of developing numerous vehicles that each serve different purposes, one vehicle can be used for different tasks by towing various implements (e.g., tillers, seeders, fertilizers, etc.). Among other advantages, towing multiple implements with one vehicle instead of having several vehicles can reduce costs of having more functionality because towing implements alone often cost less to produce than vehicles specifically adapted to provide the same functionality as the towing implements. Thus, for example, a vehicle with several towing implements requires only one engine in comparison to several vehicles that are each uniquely adapted to provide the same functionality of each towing implement.

Vehicles are adapted to tow implements in various ways. For example, a vehicle specifically designed to tow an implement may have different braking systems to account for hauling more weight. Another necessary adaptation is that the vehicle must have a manner of connecting the towing implement to the vehicle. Unfortunately, because different manufacturers provide towing implements with different connection types and because various connection types have different advantages depending on the towing implement, among other things, a vehicle with only one connection type may be insufficient to meet all needs.

Two examples of connection types include a ball hitch and a pin hitch. A ball hitch generally takes the form of a spherical connecting point at which a corresponding coupler on the towing implement may interface, thereby forming the connection. Ball hitches may be of various sizes. For example, a ball may be 50 mm, 1⅞ in., 2 in., or 2 5/16 in., depending on size of the intended load. Often designed for lighter loads, pin hitches are common with vehicles such as lawn mowers, farm machinery, and other similar vehicles, although pin hitches may be used for any suitable purpose.

Because a vehicle may tow various implements, which may have different types and/or sizes of hitches, various solutions exist that allow a user to easily change the hitch on the vehicle. For example, a tow bar is often mounted to the chassis of a vehicle. The tow bar may, for example, have a receiving member for receiving the tongue of an apparatus containing a ball mount and ball or a pin hitch. Thus, in one example, a user may interchange a ball hitch or a pin hitch into the receiving member of the tow bar depending on the desired towing implement and more specifically whether the towing implement requires using a ball hitch or a pin hitch.

While interchangeable tongues provide the desired functionality of being able to tow different towing implements with different connection types, interchangeable tongues have disadvantages. For example, the hitch must be switched, which takes time. Furthermore, the unused hitch must be stored.

To overcome these disadvantages, one solution is a dual hole receiver hitch that has both a ball and a hole for a pin. The hole for the pin hitch is located in back of the ball attachment, i.e., the tongue portion extends beyond the ball and contains a hole so as to create a pin hitch adjacent to the ball. This allows a user to use the same hitch as either a ball hitch or a pin hitch without the disadvantages of switching a separate ball hitch and a pin hitch in the receiving member. This solution, however, also has disadvantages. For example, the protrusion of the material of the tongue portion that contains the pin hole may itself interfere with the connection, depending on the design of the towing implement and its interfacing connecting mechanism. Additionally, the material extending beyond the ball can cause problems when a towing implement is not attached. For example, a person may bump into the extra material, thereby causing an injury.

For these reasons, among others, a need exists for a hitch that overcomes the disadvantages of the currently known solutions.

### SUMMARY

In one example, a swivel multi-hitch includes a tongue including a first end in opposition to a second end and a ball having a longitudinal axis, wherein the first end is adapted to be connected to a vehicle and the second end extends therefrom. The ball is connected adjacent the second end. The swivel multi-hitch also includes a swivel plate having a mounting aperture and a hitch opening wherein the swivel plate is pivotally connected at the mounting aperture to the tongue about the longitudinal axis of the ball and is configured to be selectively mountable between a work orientation and a storage orientation. Furthermore, a fixation plate is connected to the tongue about the longitudinal axis of the ball such that the swivel plate is disposed between the fixation plate and the tongue. When the swivel plate is disposed in the storage orientation the hitch opening is disposed adjacent to the vehicle and when the swivel plate is disposed in the work orientation the hitch opening is disposed extended from the ball.

In another example, the swivel plate of the swivel multi-hitch includes a first locking aperture and the fixation plate includes a second locking aperture. A locking element is inserted through the first and second locking apertures to secure the swivel plate in the work orientation.

Furthermore, in yet another example, the swivel plate may also include a third locking aperture, such that the locking element may be inserted through the third and the second locking apertures to secure the swivel plate in the storage orientation.

Additionally, a method for using a swivel multi-hitch on a vehicle, such as the swivel multi-hitch described throughout, includes placing on the back end of a vehicle a swivel multi-hitch; removing a locking element from the second and third locking apertures, pivoting the swivel plate until the first and second locking apertures align; and inserting the locking element through the first and second locking apertures in the work orientation.

### BRIEF DESCRIPTION OF THE DRAWINGS

The features described in this disclosure are set forth with particularity in the appended claims. These features and attendant advantages will become apparent from consideration of the following detailed description, taken in conjunction with the accompanying drawings. One or more embodiments are now described, by way of example only, with reference to the accompanying drawings wherein like reference numerals represent like elements and in which:

FIG. 1 is an exploded perspective view of an example embodiment of a swivel multi-hitch.

FIG. 2 is a perspective view of an example embodiment of a swivel multi-hitch with a swivel plate in a work orientation.

FIG. 3 is a perspective view of an example embodiment of a swivel multi-hitch with a swivel plate in a storage orientation.

FIG. 4 is a top plan view of an example embodiment of a swivel multi-hitch with a swivel plate in a storage orientation.

FIG. 5 is a side plan view of an example embodiment of a swivel multi-hitch with a swivel plate in a storage orientation.

FIG. 6 is a front view of an example embodiment of a swivel multi-hitch with a swivel plate in a storage orientation.

FIG. 7 is a flowchart showing one example method for using a swivel multi-hitch on a vehicle.

### DETAILED DESCRIPTION

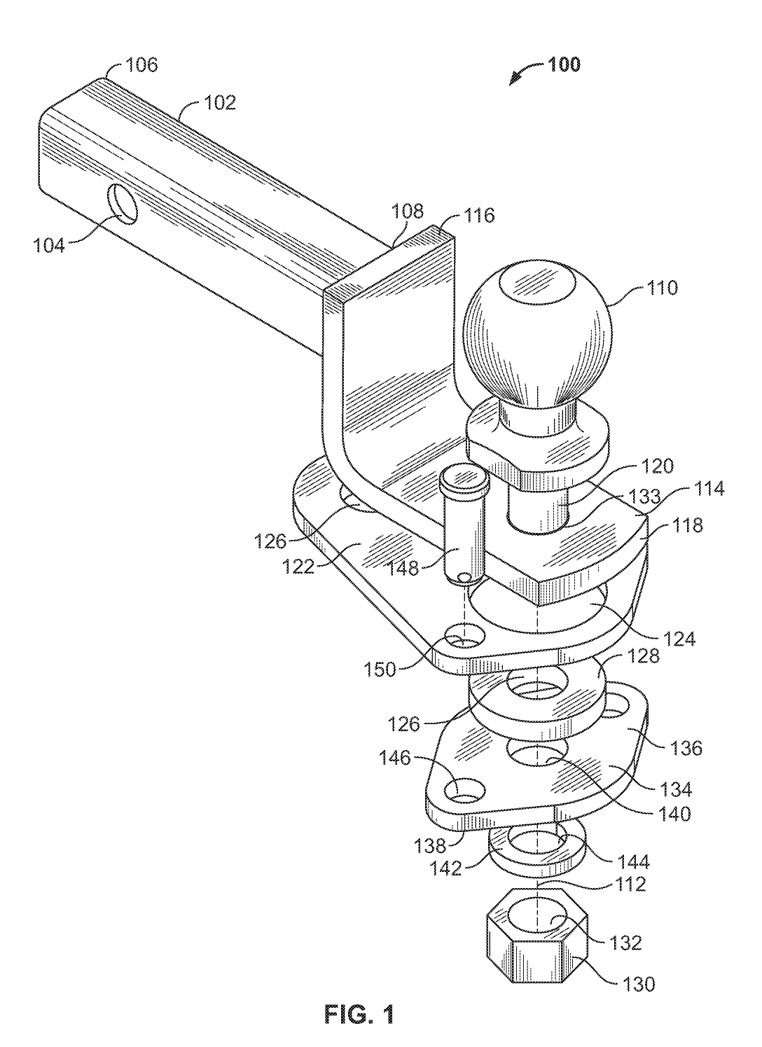

A swivel multi hitch 100 is best shown in FIGS. 1-6. FIG. 1 shows an exploded view of a swivel multi-hitch. As shown, swivel multi-hitch 100, sometimes referred to as a “hitch” throughout, has tongue 102, designed to be received by a receiving member (not shown) mounted to a vehicle, preferably to the chassis of the vehicle. Tongue 102 may be of any suitable size as known in the art, and the size is most often determined based upon industry standards and the weight of the loads for which the hitch will be used to tow. Tongue 102, as known in the art, contains a tongue locking aperture 104, which secures the swivel multi-hitch 100 to a vehicle when the tongue 102 is inserted into a receiving member on the tow bar, which is attached to the vehicle. For example, a hitch locking element, such as a pin, (not shown) may be inserted through tongue locking aperture 104, as known in the art, to secure the multi-hitch 100 to the vehicle.

Tongue 102 also contains a first end 106 in opposition to a second end 108. The first end 106 is adapted to be connected to a vehicle in any suitable manner. Although inserting first end 106 into a receiving member of a tow bar is a common manner for connecting first end 106 to a vehicle, it is understood that any suitable manner may be used. For example, first end 106 could be adapted to be secured directly or indirectly to a vehicle with bolts, screws, welds, or any other suitable means known in the art. This particular example having a tongue locking aperture 104 is preferred because it allows hitches of different sizes to be easily interchanged with one common receiving member of a tow bar. One skilled in the art, however, will recognize that any suitable connection means is within the spirit of this disclosure. It is further recognized that the tongue 102 and its first end 106 may be more permanently connected to a vehicle. For example, it is contemplated that the tongue 102 and first end 106 may be a part of a vehicle's chassis itself.

The second end 108 is adjacent to a ball 110, having a longitudinal axis 112 represented by a dotted line. Although ball 110 is shown as a generally spherical ball, it is understood that any suitable ball or other connecting device known in the art may also be used. While it is contemplated that ball 110 may be connected to a straight tongue 102, the embodiment shown contains an L-shaped metal plate 114 connected to second end 108. The L-shaped metal plate 114 contains a top surface 116 and bottom surface 118, and as shown, a body 120 (e.g., a shank) of ball 110 may connect ball 110 to bottom surface 118 of the L-shaped metal plate 114. Thus, L-shaped metal plate 114 serves as an extension of tongue 102, providing advantages known in the art, such as providing different heights relative to the ground surface to account for variations of heights of vehicles and towing implements.

Swivel plate 122 contains a mounting aperture 124 and a hitch opening 126. Hitch opening 126, as known in the art, may be used as a pin hitch connection for towing an implement. A circular aperture is preferred, but it is recognized that hitch opening 126 may be any other suitable shape. The swivel plate 122 is pivotally connected at the mounting aperture 124 to the tongue 102 about the longitudinal axis 112 of the ball 110. In the embodiment shown, the body 120 of ball 110 passes through aperture 126 of a lock spacer 128. The body 120 is along the longitudinal axis 112 of the ball 110 and coupled with the ball 110, serves as a pivot for the swivel plate 122. Lock spacer 128 is of a thickness slightly greater than the thickness of swivel plate, which as one skilled in the art will appreciate, allows swivel plate 122 to pivot about the longitudinal axis 112 of the ball 110 when secured to the body 120 with a lock nut 130, containing aperture 132. As one skilled in the art will appreciate, locking nut 130 may be threaded such that the aperture 132 is formed by a threaded surface to connect to body 120 of ball 110. As best shown in FIG. 5, body 120 may include a locking end 133 in opposition to the ball 110 along the longitudinal axis 112, thereby allowing lock nut 130 on the locking end 133 to secure the fixation plate 134 to the tongue 102.

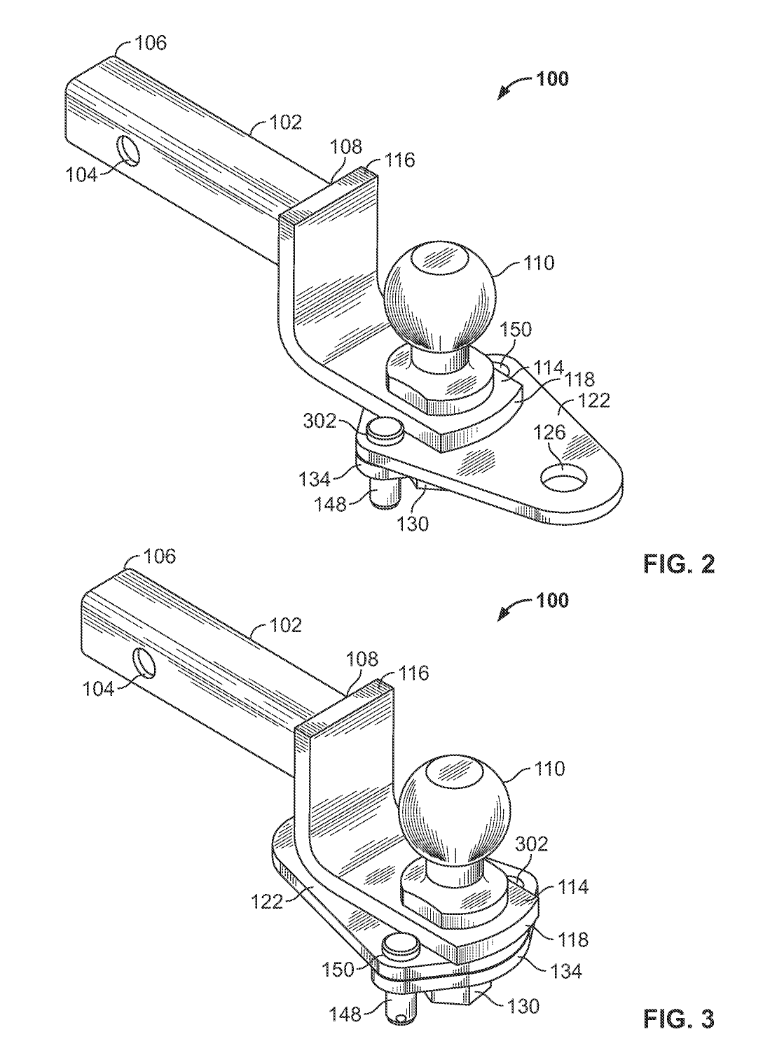

Thus, the swivel plate 122 is configured to be selectively mountable between a work orientation and a storage orientation. A storage orientation, for example, is best shown in FIGS. 1 and 3-6. A work orientation is best shown in FIG. 2. In the storage orientation, the hitch opening 126 is disposed adjacent to the vehicle under the tongue 102 of the swivel multi-hitch. It is also contemplated, however, that the swivel plate 122 could be in any other suitable position, such as above or next to the tongue 102. When disposed in the work orientation, as shown in FIG. 2, the hitch opening 126 extends from the ball 110. As one skilled in the art will appreciate, the work orientation allows a user to use hitch opening 126 with a connecting pin to connect the pin hitch to a towing implement using a pin hitch configuration. Although the work orientation shows hitch opening 126 positioned to be as distant from first end 106 as possible, it is understood that any suitable work orientation that allows a user to use the swivel plate 122 in a pin hitch connecting configuration may be used.

As described thus far, swivel plate 122 is freely pivotable about the longitudinal axis 112 of ball 110. Thus, a fixation plate 134 is connected to the tongue 102 about the longitudinal axis 112 of the ball 110 such that the swivel plate 126 is disposed between the fixation plate 134 and the tongue 102. As best shown in FIG. 1, fixation plate 134 abuts lock spacer 128 on a top surface 136. A lock nut 130 having aperture 132 abuts bottom surface 138 of fixation plate 134. A locking washer 142 with aperture 144 may also be placed between the fixation plate 134 and the lock nut 130, as one skilled in the art will appreciate the benefits of such a locking washer 142 or any other suitable components.

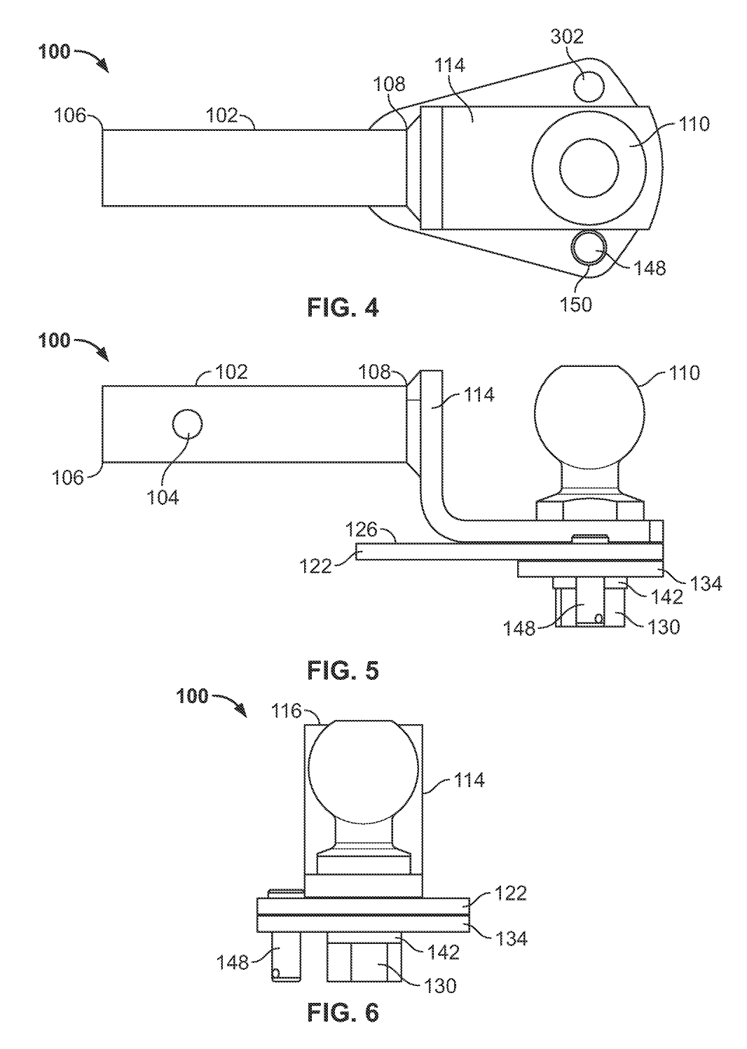

The swivel plate 122, as best shown in FIGS. 3 and 4, may also include a first locking aperture 302. As best shown in FIG. 1, fixation plate 134 includes a second locking aperture 146. A locking element 148 is inserted through the first locking aperture 302 and the second locking aperture 146 to secure the swivel plate 122 in the work orientation. Locking element 148 may be any suitable device, such as a pin. It is understood that any suitable locking element may be used, however.

The swivel plate 122, in one embodiment, also includes a third locking aperture 150. Thus, swivel plate 122 may be pivoted about longitudinal axis 112 such that the hitch opening 126 is disposed under the tongue 102, and locking element 148 may be inserted through the third locking aperture 150 on the swivel plate 122 and the second locking aperture 146 on the fixation plate 134, thereby securing the swivel plate 122 in the storage orientation. Thus, the hitch opening 126 may be securely positioned so as to minimize potential dangers of extra protruding material when the pin hitch connection is not in use.

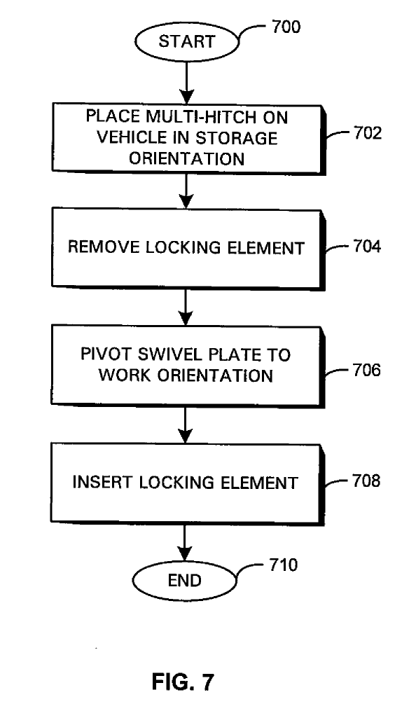

A method for using a swivel multi-hitch 100 on a vehicle is also shown in FIG. 7, starting as shown in block 700. The method is described along with swivel multi-hitch 100 as described above, but it is understood that the method may be used with any suitable device or apparatus of combination thereof. As shown in block 702, the method includes placing a multi-hitch 100 on a vehicle in a storage orientation. The swivel multi-hitch 100 may be similar to the swivel multi-hitch 100 described above that includes a tongue 102 with a first end 106 in opposition to a second end 108 and a ball 110 with a longitudinal axis 112. The first end 106 is adapted to be connected to the back of the vehicle, and the second end 108 extends therefrom. The ball 110 is connected adjacent the second end 112, as is described above. The swivel multi-hitch may also include a swivel plate 122 having a mounting aperture 124 and a hitch opening 126 wherein the swivel plate 122 is pivotally connected at the mounting aperture 124 to the tongue 102 about the longitudinal axis 112 of the ball 110 and is configured to be selectively mountable between a work orientation and a storage orientation.

As described in more detail throughout, the swivel multi-hitch 100 may also include a fixation plate 134 connected to the tongue 102 about the longitudinal axis 112 of the ball 110 such that the swivel plate 122 is disposed between the fixation plate 134 and the tongue 102. When the swivel plate 122 is disposed in a storage orientation, as shown for example in FIGS. 1 and 3-6, the hitch opening 126 is disposed adjacent to the vehicle. When the swivel plate 122 is disposed in the work orientation, as best shown in FIG. 2, the hitch opening 126 is disposed extended from the ball 110. The swivel plate 122 may also have a first locking aperture 302 and a third locking aperture 150, while the fixation plate 134 may have a second locking aperture 146. As described in more detail above in one example embodiment, a locking element 148 is inserted through the third locking aperture 150 and the second locking aperture 146 to secure the swivel plate 122 in the storage orientation.

As shown in block 704, the method includes removing the locking element 148 from the second locking aperture 146 and the third locking aperture 150. This removal of the locking element may be done by a user manually or may be performed by any suitable automated or assisted means. As shown in block 706, the method next includes pivoting the swivel plate 122 to a work orientation, which may further include swiveling the swivel p late 122 such that the first locking aperture 302 and second locking aperture 146 align.

Before ending as shown in block 710, the method may include inserting the locking element 148 through the first locking aperture 302 and the second locking aperture 146 in the work orientation. It is understood that this example method may include additional suitable steps before, after, or between the steps described herein.

While particular embodiments have been shown and described, it will be obvious to those skilled in the art that changes and modifications may be made without departing from the instant teachings. It is therefore contemplated that any and all modifications, variations or equivalents of the above-described teachings fall within the scope of the basic underlying principles disclosed above and claimed herein.

1. A swivel multi-hitch, comprising:
a tongue comprising a first end in opposition to a second end and a ball having a longitudinal axis, wherein the first end is adapted to be connected to a vehicle and the second end extends therefrom and the ball is connected adjacent the second end;
a swivel plate comprising a mounting aperture and a hitch opening wherein the swivel plate is pivotally connected at the mounting aperture to the tongue about the longitudinal axis of the ball and is configured to be selectively mountable between a work orientation and a storage orientation;
a fixation plate connected to the tongue about the longitudinal axis of the ball such that the swivel plate is disposed between the fixation plate and the tongue; and
wherein when the swivel plate is disposed in the storage orientation the hitch opening is disposed adjacent to the vehicle and when the swivel plate is disposed in the work orientation the hitch opening is disposed extended from the ball.

2. The swivel multi-hitch of claim 1, wherein the swivel plate comprises a first locking aperture and the fixation plate comprises a second locking aperture, wherein a locking element is inserted through the first and second locking apertures to secure the swivel plate in the work orientation.

3. The swivel multi-hitch of claim 2, wherein the swivel plate comprises a third locking aperture, and wherein the locking element is inserted through the third and the second locking apertures to secure the swivel plate in the storage orientation.

4. The swivel multi-hitch of claim 1, wherein the hitch opening is a circular aperture.

5. The swivel multi-hitch of claim 2, wherein the locking element is a pin.

6. The swivel multi-hitch of claim 3, wherein the locking element is a pin.

7. The swivel multi-hitch of claim 1, wherein a body along the longitudinal axis of the ball and coupled with the ball serves as a pivot for the swivel plate.

8. The swivel hitch of claim 7, wherein the body further includes a locking end in opposition to the ball along the longitudinal axis and where a lock nut on the locking end secures the fixation plate to the tongue.

9. A method for using a swivel multi-hitch on a vehicle, the method comprising:
placing on the back end of a vehicle a swivel multi-hitch comprising a tongue having a first end in opposition to a second end and a ball having a longitudinal axis, wherein the first end is adapted to be connected to the back of the vehicle and the second end extends therefrom and the ball is connected adjacent the second end, a swivel plate having a mounting aperture and a hitch opening wherein the swivel plate is pivotally connected at the mounting aperture to the tongue about the longitudinal axis of the ball and is configured to be selectively mountable between a work orientation and a storage orientation, a fixation plate connected to the tongue about the longitudinal axis of the ball such that the swivel plate is disposed between the fixation plate and the tongue, and wherein when the swivel plate is disposed in the storage orientation the hitch opening is disposed adjacent to the vehicle and when the swivel plate is disposed in the work orientation the hitch opening is disposed extended from the ball, and wherein the swivel plate comprises a first locking aperture and a third locking aperture and the fixation plate having a second locking aperture and wherein a locking element is inserted through the third and second locking apertures to secure the swivel plate in the storage orientation;
removing the locking element from the second and third locking apertures;
pivoting the swivel plate until the first and second locking apertures align; and
inserting the locking element through the first and second locking apertures in the work orientation.
